(19) United States
(12) Patent Application Publication
(10) Pub. No.: US 2014/0192060 A1
(43) Pub. Date: Jul. 10, 2014

(54) CONTROLLING MOVABLE LAYER SHAPE FOR ELECTROMECHANICAL SYSTEMS DEVICES

(71) Applicant: QUALCOMM MEMS TECHNOLOGIES, INC., San Diego, CA (US)

(72) Inventors: Yi Tao, San Jose, CA (US); Fan Zhong, Fremont, CA (US); Lixia Zhou, Milpitas, CA (US)

(73) Assignee: QUALCOMM MEMS TECHNOLOGIES, INC., San Diego, CA (US)

(21) Appl. No.: 13/736,775

(22) Filed: Jan. 8, 2013

(51) Int. Cl. G02B 26/00; G06T 1/00

(52) U.S. Cl. CPC G02B 26/001; G06T 1/00
USPC 345/501; 359/291; 427/58; 29/592.1

(57) ABSTRACT

Systems, methods and apparatus are provided for controlling launch effects of movable layers in electromechanical systems (EMS) devices. First and second EMS devices with first and second step creating layers are positioned over a substrate and spaced, by different gaps, from the movable layers of the EMS devices. The movable layers of the first and second EMS devices include steps having different heights and/or different edge spacing from the center of an anchoring region of each EMS device. The different steps can provide different launch effects for different EMS devices, and if the same thickness of sacrificial material is used for the different devices, the different launch effects can be responsible for different gap heights in the unbiased conditions.

### TECHNICAL FIELD

This disclosure relates to electromechanical systems and devices, and more particularly, to controlling the shape of the movable layer in such devices and systems.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

An EMS device can include a movable layer that is anchored to a substrate at supports. In some applications, different EMS devices can have different gap sizes between the movable layer and the substrate in an open state. For example, in an IMOD array, different EMS devices can represent different pixels for interferometrically reflecting different colors. The different sized gaps can produce the different interferometrically reflected colors by providing different optical path lengths for light incident on the pixel or device in an open condition.

### SUMMARY

The systems, methods and devices of this disclosure each have several innovative aspects, no single one of which is solely responsible for the desirable attributes disclosed herein.

One innovative aspect of the subject matter described in this disclosure can be implemented in an array of electromechanical systems (EMS) devices. The array includes a substrate, a first EMS device and a second EMS device. The first EMS device includes a first step creating layer within a first anchoring region and a first movable layer spaced from the substrate by a first gap. The first movable layer is anchored to the substrate at the first anchoring region which has a first geometric center point in a lateral plane. The first movable layer includes a first step which has a first height and is laterally spaced from the first geometric center point by a first distance. The second EMS device includes a second step creating layer within a second anchoring region and a second movable layer spaced from the second step creating layer and spaced from the substrate by a second gap. The second movable layer is anchored to the substrate at the second anchoring region. The second anchoring region has a second geometric center point in the lateral plane. The second movable layer includes a second step which has a second height and is laterally spaced from the second geometric center point by a second distance. The first distance is different from the second distance or the first height is different from the second height, or both.

In some implementations, in unbiased states, the second movable layer defines a height for the second gap that is higher than a height for the first gap defined by the first movable layer. In some implementations, an edge of the first step creating layer is spaced a first length from the first geometric center point, an edge of the second step creating layer is spaced a second length from the second geometric center point, and the second length is longer than the first length. The first movable layer and the second movable layer can exhibit curvature away from the substrate in an unbiased state. In some implementations, at least one of the first and second step creating layers includes a signal bussing layer. The first step can be spaced from the first geometric center point by about 4.5 μm-5.5 μm and the second step can be spaced from the second geometric center point by about 6 μm-7 μm. The first EMS device and the second EMS device can be interferometric modulators. In some implementations, an edge of the first step creating layer can be spaced a first length from the first geometric center point, and an edge of the second step creating layer can be spaced a second length from the second geometric center point. The first EMS device and the second EMS device can include black mask structures within the first and the second anchoring regions and extending a length from the geometric center points of the first and the second anchoring regions, the length longer than the first and second lengths.

In some implementations, the first height of the first step can be about 80 nm-180 nm and the second height of the second step can be about 210 nm-310 nm. The thickness of the first step creating layer can correspond to the first height and a thickness of the second step creating layer can correspond to the second height. In some implementations, in unbiased states, the second movable layer defines a height for the second gap that is higher than a height for the first gap defined by the first movable layer, and the second height of the second step is higher than the first height of the first step.

Another innovative aspect of the subject matter described in this disclosure can be implemented in a method of manufacturing an array of EMS devices. The method includes providing a substrate, providing a first EMS device, and providing a second EMS device. Providing the first EMS device includes forming a first step creating layer over the substrate in a first anchoring region having a first geometric center point. Providing the first EMS device also includes depositing a first sacrificial layer over the first step creating layer, thereby propagating a step from the first step creating layer to the first sacrificial layer. Providing the first EMS device also includes depositing a first movable layer over the first sacrificial layer, thereby propagating the step to the first movable layer to form a first step in the first movable layer, the first step being laterally spaced from the first geometric center point by a first distance, the first step having a first height. Providing the second EMS device includes forming a second step creating layer over the substrate in a second anchoring region having a second geometric center point. Providing the second EMS device also includes depositing a second sacrificial layer over the second step creating layer, thereby propagating an other step from the second step creating layer to the second sacrificial layer. Providing the second EMS device also includes depositing a second movable layer over the second sacrificial layer, thereby propagating the other step to the second movable layer to form a second step in the second movable layer, the second step being laterally spaced from the second geometric center point by a second distance, the second step having a second height. The first height is different from the second height or the first distance is different from the second distance, or both.

In some implementations, the first step creating layer has a first thickness and has an edge spaced a first length from the first geometric center point to an edge of the first step creating layer and the second step creating layer has a second thickness and has an edged spaced a second length from the second geometric center point to an edge of the second step creating layer. The first thickness can be different from the second thickness or the first length can be different from the second length. In some implementations, depositing the first sacrificial layer and depositing the first movable layer are conformal depositions over the first step creating layer, and depositing the second sacrificial layer and depositing the second movable layer are conformal depositions over the second step creating layer. Depositing the first sacrificial layer and depositing the second sacrificial layer can include forming a single thickness of sacrificial material in the first and second EMS devices. In some implementations, the method can include removing the sacrificial layer to form a first gap having a first gap height in the first EMS device and a second gap having a second gap height in the second EMS device, the first gap height being different from the second gap height in unbiased states. The first EMS device and the second EMS device can be interferometric modulators. The first EMS device and the second EMS device can be configured to reflect different colors.

Another innovative aspect of the subject matter described in this disclosure can be implemented in an array of EMS devices including a substrate, a first EMS device on the substrate and a second EMS device on the substrate. The first EMS device includes a stationary electrode, a first movable electrode and a first launch defining means for defining a degree of deviance of the first movable electrode from an unreleased state to a released and unbiased state. The first launch defining means is spaced by a gap from the first movable electrode. The second EMS device includes a stationary electrode, a second movable electrode and a second launch defining means for defining a degree of deviance of the second movable electrode from an unreleased state to a released and unbiased state. The second launch defining means is spaced by a gap from the second movable electrode. The first launch defining means and the second launch defining means differ in one or more characteristics.

In some implementations, the first and second launch defining means include first and second step creating layers, respectively. The first launch defining means can have a different height than the second launch defining means. In some implementations, an edge of the first launch defining means is spaced a first distance from a geometric center point of a first anchoring region of the first movable electrode, and an edge of the second launch defining means is spaced a second distance from a geometric center point of a second anchoring region of the second movable electrode, the first distance different from the second distance. The first launch defining means can include a first layer within the first anchoring region and the second launch defining means can include a second layer within the second anchoring region. The first EMS device and the second EMS device can be interferometric modulators configured to reflect different colors. In some implementations, the first launch defining means includes a layer positioned over a black mask structure and the second launch defining means includes a layer positioned over a black mask structure.

Another innovative aspect of the subject matter described in this disclosure can be implemented in an array of EMS devices. The array includes a substrate and a first and second EMS device on the substrate. The first EMS device includes a first movable layer and a first support for supporting the first movable layer and spacing the first movable layer from the substrate by a first gap. The second EMS device includes a second movable layer and a second support for supporting the second movable layer and spacing the second movable layer from the substrate by a second gap. The first support and the second support have a same width and a same height relative to the substrate. The first EMS device and the second EMS device have different gap heights in unbiased states.

In some implementations, the first support is integrated with the first movable layer to form a first self-supporting movable layer and the second support is integrated with the second movable layer to form a second self-supporting movable layer. In some implementations, a height of the second gap is higher than a height of the first gap. An edge of the first step creating layer can be spaced a first distance from a geometric center point of the first support and an edge of the second step creating layer can be spaced a second distance from a geometric center point of the second support. The second distance can be longer than the first distance. In some implementations, the first EMS device includes a first step creating layer in a first anchor region about the first support and the second EMS device includes a second step creating layer in a second anchor region about the second support, the first step creating layer spaced from the first movable layer and the second step creating layer spaced from the second movable layer, and a height of the second step creating layer higher than a height of the first step creating layer. In some implementations, the first EMS device and the second EMS device share a same post and an edge of the first step creating layer is spaced a first distance from a first geometric center point of the post and an edge of the second step creating layer is spaced a second distance from a second geometric center point of the post, the first distance being different from the second distance.

The first movable layer can include a first step and the second movable layer can include a second step. The first step can be spaced a first distance from a first geometric center point of the first support and the second step can be spaced a second distance from a second geometric center point of the second support. The first distance can be different from the second distance and/or the first and second steps have a different height.

In some implementations, the first EMS device includes a first step creating layer in a first anchor region about the first support and the second EMS device includes a second step creating layer in a second anchor region about the second support, the first step creating layer spaced from the first movable layer and the second step creating layer spaced from the second movable layer. The second step creating layer can have a greater thickness than the first step creating layer. The height of the first step can correspond to the thickness of the first step creating layer and the height of the second step can correspond to the thickness of the second step creating layer. An edge of the first step creating layer can be spaced a first length from a first geometric center point of the first support and an edge of the second step creating layer can be spaced a second length from a second geometric center point of the second support. The first distance can correspond to the first length and the second distance can correspond to the second length.

The first step creating layer can be positioned over a black mask structure and around the first support of the first EMS device and the second step creating layer can be positioned over a black mask structure and around the second support of the second EMS device.

Another innovative aspect of the subject matter described in this disclosure can be implemented in a method of manufacturing an array of EMS devices. The method includes providing a substrate and providing a sacrificial layer having a substantially uniform thickness over the substrate. The method also includes providing openings in the sacrificial layer for receiving a first support for supporting a first movable layer and a second support for supporting a second movable layer, the first and second supports having the same height and width relative to the substrate. The method also includes providing the first support and the second support in the openings. The method includes providing the first movable layer and the second movable layer over the sacrificial layer in contact with the first support and the second support, respectively. The method also includes removing the sacrificial layer to release the first and second movable layers and define a first EMS device having a first gap height and a second EMS device having a second gap height, the first gap height different from the second gap height in unbiased states.

In some implementations, removing the sacrificial layer causes the first and second movable layers to launch, curving away from the substrate. The method can include providing a first step creating layer in the first EMS device, the first step creating layer spaced from the movable layer by the sacrificial layer and a second step creating layer in the second EMS device, the second step creating layer spaced from the second movable layer by the sacrificial layer. The method can also include providing a black mask structure on the substrate, the black mask structure under the first step creating layer and the second step creating layer.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIGS. 2A-2E are cross-sectional illustrations of varying implementations of IMOD display elements.

FIG. 3 is a flow diagram illustrating a manufacturing process for an IMOD display or display element.

FIGS. 4A-4E are cross-sectional illustrations of various stages in a process of making an IMOD display or display element.

FIG. 5 is a cross-sectional illustration of a portion of an array of electromechanical systems (EMS) devices.

FIG. 6 is cross-sectional illustration of a portion of an array of EMS devices.

FIG. 7 is a cross-sectional illustration of a portion of an array of EMS devices.

FIG. 8 is a cross-sectional illustration of an example of an anchoring region between two EMS devices.

FIG. 9 is a plan view illustration of an array of EMS devices.

FIG. 10 is a flow diagram illustrating a manufacturing process for an array of EMS devices.

FIG. 11 is a flow diagram illustrating a manufacturing process for an array of EMS devices.

FIGS. 12A and 12B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Implementations of arrays of EMS devices having different gap heights are provided. The different gap heights can be created by adjusting launch of the movable layers of the devices, which is the degree of deviance of the movable layers from an unreleased state to a released and unbiased state upon removal of the sacrificial material. Steps of different heights and/or distances from anchor regions can adjust the launch, which can in turn be used for EMS devices of different gap heights, for example different interferometric modulators (IMODs) for reflection of different colors. The different step heights and/or distances for different devices can correspond to different step-creating layers spaced from the movable layers. The step-creating layers can be within the anchoring region and can also function as bussing layers, e.g., above a black mask layer for an IMOD embodiment. The different steps can affect launch of the movable layers to such a degree that different gap heights can be provided even with the same support structures.

Particular implementations of the subject matter described in this disclosure can be implemented to realize one or more of the following potential advantages. Using different steps to modulate launch can provide greater control over the shape of the mechanical layer after the sacrificial material is removed. Applying this control to use launch as the primary or sole factor in defining different gap sizes can reduce the complexity of fabricating IMOD structures by permitting the definition of different gap sizes with a common thickness for the sacrificial layer. A single sacrificial thickness also can reduce etch attack issues and etch-related non-uniformity entailed by multiple thicknesses of sacrificial layers for multiple different gap size devices. Furthermore, defining a thickness of sacrificial material and a single support size for devices with different gaps sizes can employ fewer depositions, fewer masks, and reduced material consumption and may ultimately reduce the cost and improve efficiency of fabricating IMOD structures. Another potential advantage is that with common post heights and widths, normalization of actuation voltage for the different device gap sizes is more easily accomplished. Finally, the ability to adjust the height of a step and the distance between a step and a geometric center point of an anchoring region provides two useful methods by which launch can be tuned, which can be employed individually or in concert.

An example of a suitable EMS or MEMS device or apparatus, to which the described implementations may apply, is an optical EMS device, such as a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical gap defined between the absorber and the reflector. In some implementations, the reflector can be moved to two or more different positions, which can change the size of the optical gap and thereby affect the reflectance of the IMOD. The reflectance spectra of IMOD display elements can create spectral bands that can be shifted across the visible wavelengths to generate different colors, including white and black. The position of the spectral band can be adjusted by changing the thickness of the optical gap. One way of changing the optical gap is by changing the position of the reflector with respect to the absorber.

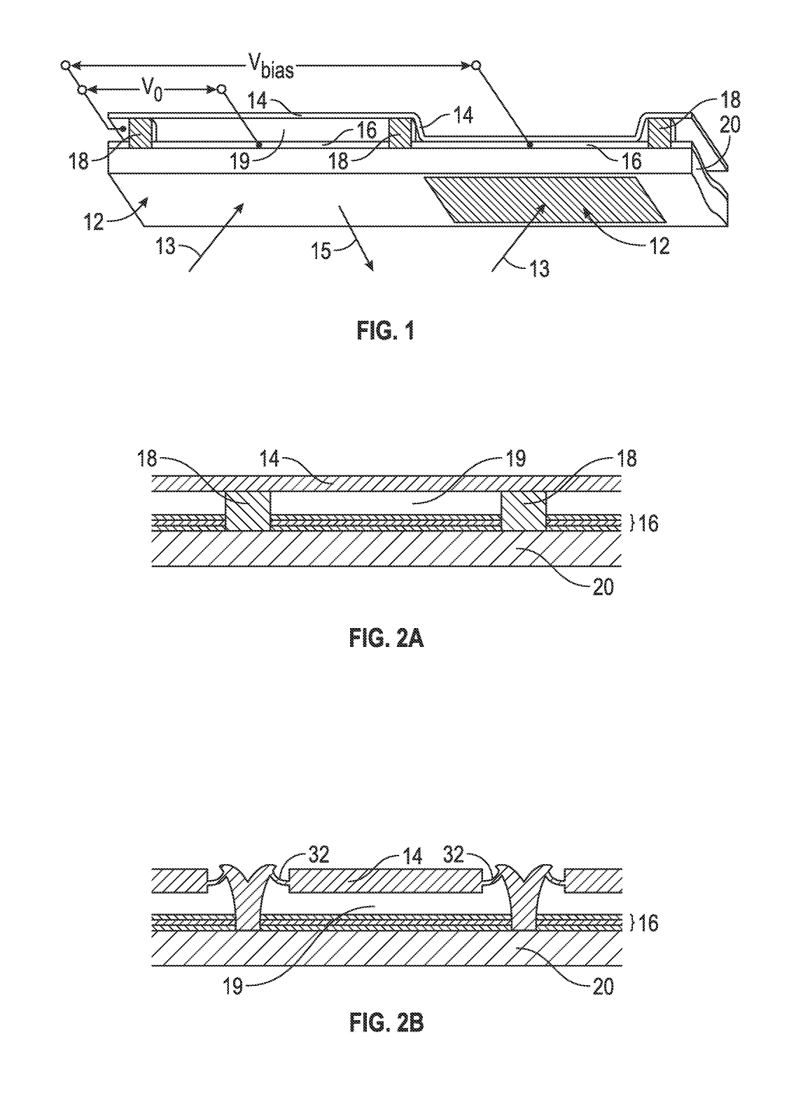

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of primary colors and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer. A conductive layer of the optical stack 16, such as a metallic optically absorptive layer, can serve as a stationary electrode structure for an EMS device.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be less than approximately 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

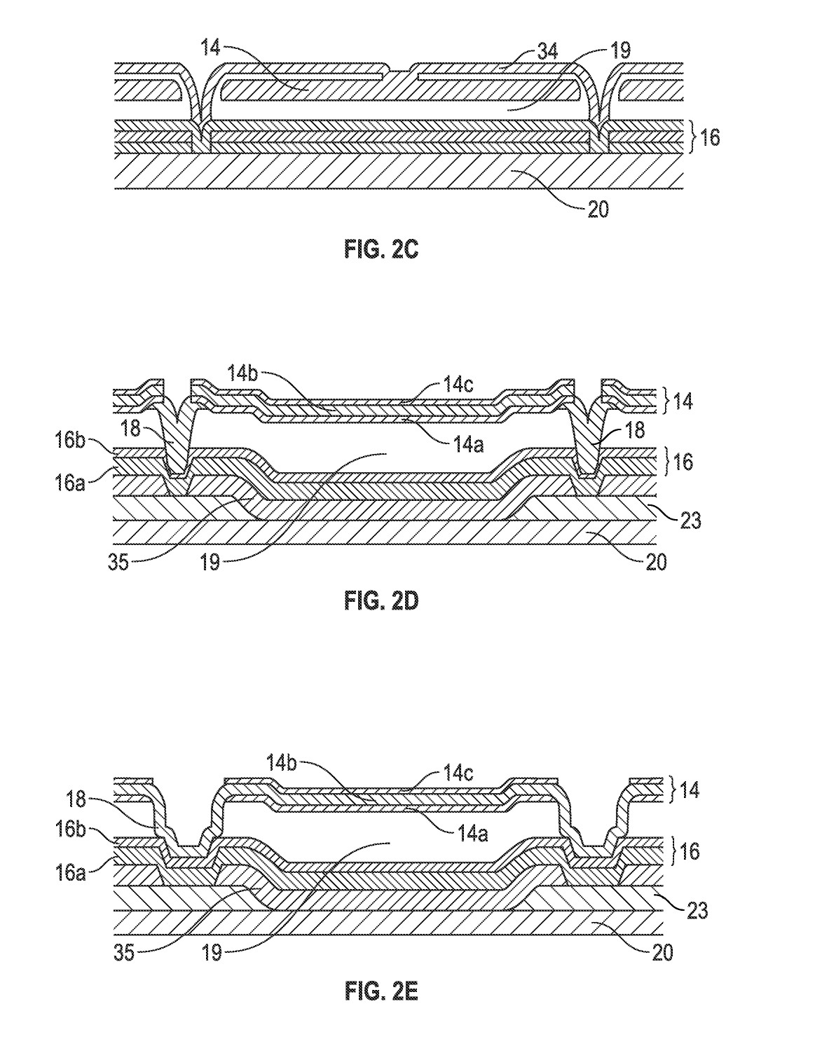

The details of the structure of IMOD displays and display elements may vary widely. FIGS. 2A-2E are cross-sectional illustrations of varying implementations of IMOD display elements. FIG. 2A is a cross-sectional illustration of an IMOD display element, where a strip of metal material is deposited on supports 18 extending generally orthogonally from the substrate 20 forming the movable reflective layer 14. In FIG. 2B, the movable reflective layer 14 of each IMOD display element is generally square or rectangular in shape and attached to supports 18 at or near the corners, on tethers 32. In FIG. 2C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as implementations of “integrated” supports or support posts 18. The implementation shown in FIG. 2C has additional benefits deriving from the decoupling of the optical functions of the movable reflective layer 14 from its mechanical functions, the latter of which are carried out by the deformable layer 34. This decoupling allows the structural design and materials used for the movable reflective layer 14 and those used for the deformable layer 34 to be optimized independently of one another.

FIG. 2D is another cross-sectional illustration of an IMOD display element, where the movable reflective layer 14 includes a reflective sub-layer 14a. The movable reflective layer 14 rests on a support structure, such as support posts 18. The support posts 18 provide separation of the movable reflective layer 14 from the lower stationary electrode, which can be part of the optical stack 16 in the illustrated IMOD display element. For example, a gap 19 is formed between the movable reflective layer 14 and the optical stack 16, when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a and 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 2D, some implementations also can include a black mask structure 23, or dark film layers. The black mask structure 23 can be formed in optically inactive regions (such as between display elements or under the support posts 18) to absorb ambient or stray light. The black mask structure 23 also can improve the optical properties of a display device by inhibiting light from being reflected from or transmitted through inactive portions of the display, thereby increasing the contrast ratio. Additionally, at least some portions of the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. In some implementations, the black mask structure 23 can be an etalon or interferometric stack structure. For example, in some implementations, the interferometric stack black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, tetrafluoromethane (or carbon tetrafluoride, CF₄) and/or oxygen (O₂) for the MoCr and SiO₂ layers and chlorine (Cl₂) and/or boron trichloride (BCl₃) for the aluminum alloy layer. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate electrodes (or conductors) in the optical stack 16 (such as the absorber layer 16a) from the conductive layers in the black mask structure 23.

FIG. 2E is another cross-sectional illustration of an IMOD display element, where the movable reflective layer 14 is self-supporting. While FIG. 2D illustrates support posts 18 that are structurally and/or materially distinct from the movable reflective layer 14, the implementation of FIG. 2E includes support posts that are integrated with the movable reflective layer 14. In such an implementation, the movable reflective layer 14 contacts the underlying optical stack 16 at multiple locations, and the curvature of the movable reflective layer 14 provides sufficient support that the movable reflective layer 14 returns to the unactuated position of FIG. 2E when the voltage across the IMOD display element is insufficient to cause actuation. In this way, the portion of the movable reflective layer 14 that curves or bends down to contact the substrate or optical stack 16 may be considered an “integrated” support post. One implementation of the optical stack 16, which may contain a plurality of several different layers, is shown here for clarity including an optical absorber 16a, and a dielectric 16b. In some implementations, the optical absorber 16a may serve both as a stationary electrode and as a partially reflective layer. In some implementations, the optical absorber 16a can be an order of magnitude thinner than the movable reflective layer 14. In some implementations, the optical absorber 16a is thinner than the reflective sub-layer 14a.

In implementations such as those shown in FIGS. 2A-2E, the IMOD display elements form a part of a direct-view device, in which images can be viewed from the front side of the transparent substrate 20, which in this example is the side opposite to that upon which the IMOD display elements are formed. In these implementations, the back portions of the device (that is, any portion of the display device behind the movable reflective layer 14, including, for example, the deformable layer 34 illustrated in FIG. 2C) can be configured and operated upon without impacting or negatively affecting the image quality of the display device, because the reflective layer 14 optically shields those portions of the device. For example, in some implementations a bus structure (not illustrated) can be included behind the movable reflective layer 14 that provides the ability to separate the optical properties of the modulator from the electromechanical properties of the modulator, such as voltage addressing and the movements that result from such addressing.

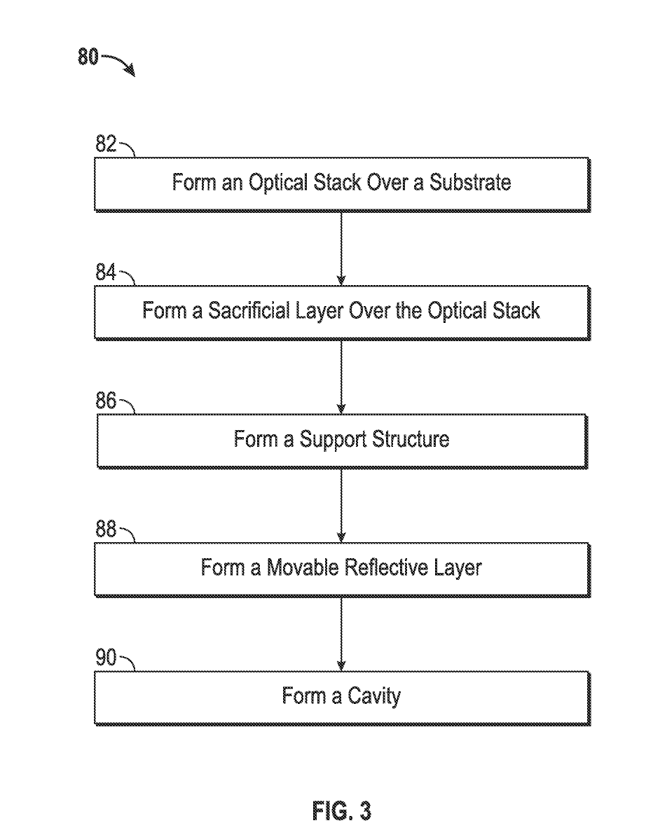

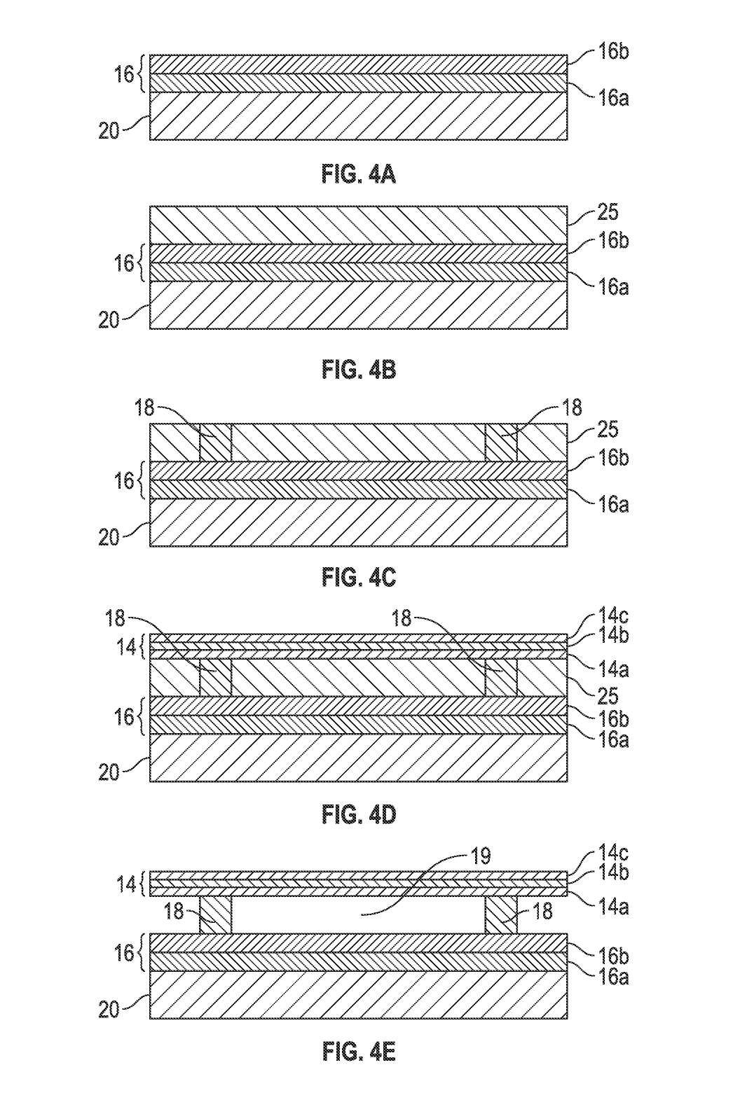

FIG. 3 is a flow diagram illustrating a manufacturing process 80 for an IMOD display or display element. FIGS. 4A-4E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 3. The process 80 begins at block 82 with the formation of the optical stack 16 over the substrate 20. FIG. 4A illustrates such an optical stack 16 formed over the substrate 20. The substrate 20 may be a transparent substrate such as glass or plastic such as the materials discussed above with respect to FIG. 1. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 4A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (e.g., relative to other layers depicted in this disclosure), even though the sub-layers 16a and 16b are shown somewhat thick in FIGS. 4A-4E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 4B illustrates a partially fabricated device including a sacrificial layer 25 formed over the optical stack 16. The formation of the sacrificial layer 25 over the optical stack 16 may include deposition of a fluorine-etchable material such as molybdenum (Mo) or amorphous silicon (Si), in a thickness selected to provide, after subsequent removal, a gap or cavity 19 (see also FIG. 4E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 4C, the aperture formed in the sacrificial layer 25 can extend through the sacrificial layer 25, but not through the optical stack 16. For example, FIG. 4E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 4C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIG. 4D. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 4D. In some implementations, one or more of the sub-layers, such as sub-layers 14a and 14c, may include metallic layers selected for their optical (e.g., reflective) and/or conductive properties, and another sub-layer 14b may include a mechanical sub-layer selected for its mechanical properties. In some implementations, the mechanical sub-layer may include a dielectric material. In some implementations, the posts 18 can be simultaneously formed, as in the self-supporting implementation of FIG. 2E. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

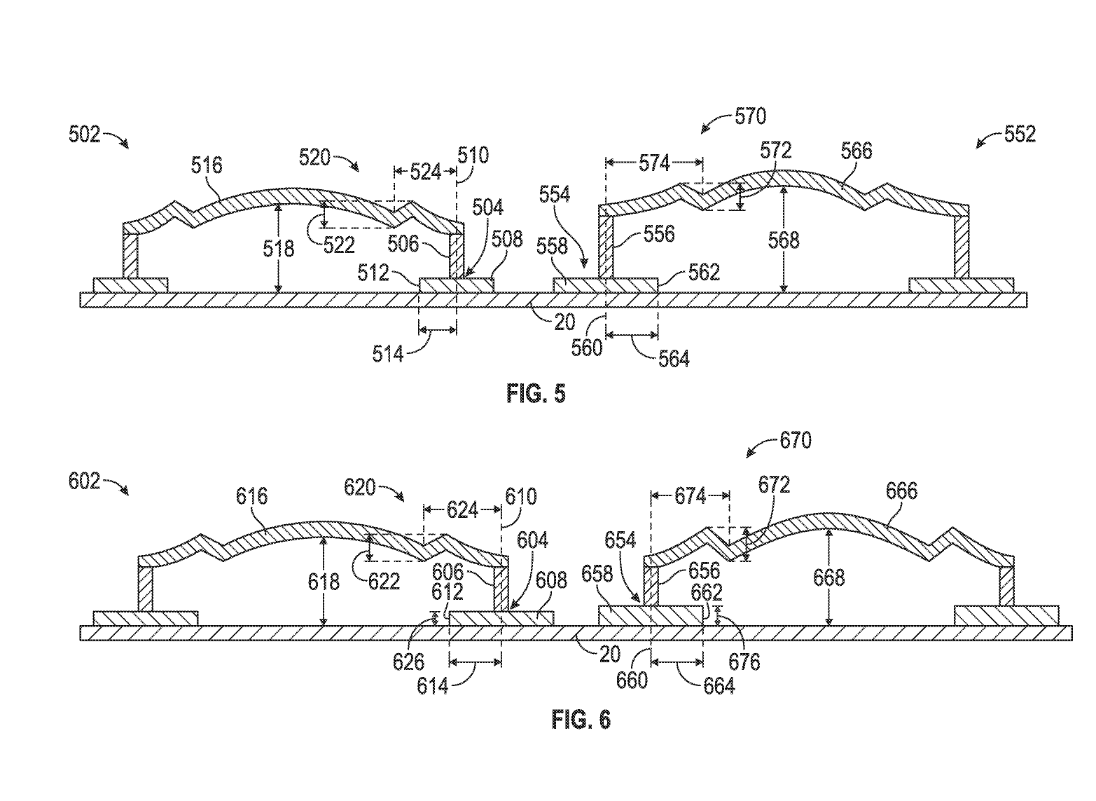

FIG. 5 is a cross-sectional illustration of a portion of an array of electromechanical systems (EMS) devices. FIG. 5 depicts a first EMS device 502 and a second EMS device 552 positioned on a substrate. The first EMS device 502 includes a first anchoring region 504 including a first support in the form of a first post 506, centered about a geometric center point 510 of the first anchoring region 504. In other arrangements the supports may take other forms, such as continuous rails or walls. The anchoring region extends beyond the boundaries of the post 506 and encompasses a larger inactive region of the array, such as an optically inactive region (e.g., black mask) of an IMOD array. The first EMS device 502 includes a first step creating layer 508 within the first anchoring region 504. An edge 512 of the first step creating layer 508 is spaced from the first geometric center point 510 by a first length 514. The first EMS device 502 includes a first movable layer 516 spaced from the substrate 20 by a first gap 518. The first movable layer 516 includes a first step 520. The first step 520 has a first height 522 and is laterally spaced from the first geometric center point 510 by a first distance 524. It will be understood by one having ordinary skill in this field that the drawings are not to scale, that the steps shown herein are exaggerated for purposes of illustration, and that the lateral dimensions of the EMS can be much larger (on the order of 10's or 100's of microns) than the vertical dimensions (on the order of 100's of nanometers).

The second EMS device 552 includes a second anchoring region 554 including a second support in the form of a second post 556, centered about a geometric center point 560 of the second anchoring region 554. In other arrangements, the supports may take other forms, such as continuous rails or walls. The second EMS device 552 includes a second step creating layer 558 within the second anchoring region 554. An edge 562 of the second step creating layer 558 is spaced from the second geometric center point 560 by a second length 564. The second EMS device 552 includes a second movable layer 566 spaced from the substrate 20 by a second gap 568. The second gap 568 can be different from the first gap 518, and in FIG. 5 the second gap 568 is shown as greater than the first gap 518. The second movable layer 566 includes a second step 570. The second step 570 has a second height 572 and is laterally spaced from the second geometric center point 560 by a second distance 574. The first distance 524 by which the first step 520 is spaced from the geometric center point 510 of the first anchoring region 504 is different from the second distance 574 by which the second step 570 is spaced from the geometric center point 560 of the second anchoring region 554.

In the illustrated implementation, the first length 514 is less than the second length 564; the first distance 524 is correspondingly less than the second distance 574; and the first gap 518 is correspondingly less than the second gap 568.

In an IMOD implementation, it will be understood that the substrate can include an optical stack, which includes a stationary electrode; in other EMS implementations, the substrate can include a stationary electrode.

The step creating layers 508 and 558 can produce steps in subsequently deposited conformal layers, leading to steps 520 and 570 in the movable layers 516 and 566. In some implementations, intervening layers are deposited over the step creating layers 508 and 558. For example, a sacrificial layer can be conformally deposited over the step creating layers 508 and 558. This conformal deposition can cause the shape of the step creating layer to be propagated upward through the sacrificial layer, causing a step in the sacrificial layer. The movable layers 516 and 566 can be conformally deposited over the sacrificial layer, which can cause the general shape of the sacrificial layer to be propagated upward through the movable layer, causing a step in the movable layer. Accordingly, the geometry of the step creating layers 508 and 558 can correspond to the geometry of the steps 520 and 570 in the movable layers 516 and 566. The distances by which the first step 520 is spaced from the geometric center point 510 can correspond to the distance by which the edge 512 of the step creating layer 508 is spaced form the geometric center point 510. In some implementations, the distance by which the second step 570 is spaced from the geometric center point 560 of the anchoring region 554 can correspond to the distance by which edge 562 of the second step creating layer 558 is spaced from geometric center point 560 of the anchoring region 554.

Note that the terms “correspondence” or “corresponding” do not imply identicality, but rather merely reflect the degree of correspondence indicative of conformal depositions between the step creating layers 508 and 558 and the movable layers 516 and 566. The geometry of the steps 520 and 570 is not necessarily equal to the geometry of the step creating layers 508 and 558 as the depositions over the step creating layers 508 and 558 can cause some deviation or shifting of the geometry of the steps 520 and 570 and their distances from the geometric center point, as compared to the edges of the step-creating layers 508 and 558. Accordingly, as the distances between an edge of the step creating layers 508 and 558 and the geometric center points 510 and 560 increase, the distances between the steps 520 and 570 and the geometric center points 510 and 560 increase.

FIG. 6 is a cross-sectional illustration of a portion of an array of EMS devices. The array includes a first EMS device 602 and a second EMS device 652 arranged on a substrate 20. The first EMS device 602 includes a first anchoring region 604 sharing a geometric center point 610 with a support in the form of a first post 606. In other arrangements the supports may take other forms, such as continuous rails or walls. The first EMS device 602 includes a first step creating layer 608 in the first anchoring region 604. An edge 612 of the first step creating layer 608 is spaced from the first geometric center point 610 by a first length 614. The first EMS device 602 includes a movable layer 616 spaced from the substrate 20 by a first gap 618. The first movable layer 616 includes a first step 620. The first step 620 has a first height 622 and is laterally spaced from the first geometric center point 610 by a first distance 624.

The second EMS device 652 includes a second anchoring region 654 that shares a geometric center point 660 with a support in the form of a second post 656. In other arrangements the supports may take other forms, such as continuous rails or walls. The second EMS device 652 includes a second step creating layer 658 within the second anchoring region 654. An edge 662 of the second step creating layer 658 is spaced from the second geometric center point 660 by a second length 664. The second EMS device includes a second movable layer 666 spaced from the substrate 20 by a second gap 668. The second movable layer 666 includes a second step 670. The second step 670 has a second height 672 and is laterally spaced from the geometric center point 660 by a second distance 674. The first height 622 of the first step 620 is different from the second height 672 of the second step 670.

In the illustrated implementation, the thickness 626 of the first step creating layer 608 is less than the thickness 676 of the second step creating layer 658; the height 622 of the first EMS device 602 is correspondingly less than the height 672 of the second EMS device 652; and the first gap 618 is correspondingly less than the second gap 668.

As noted above, the step creating layers 608 and 658 can be used to form steps 620 and 670 in the movable layers 616 and 666 deposited above the step creating layers 608 and 658. In particular, one or more layers, including a sacrificial layer and the movable layers 616 and 666, can be deposited over the step creating layers 608 and 658, thereby propagating the geometric features of the step creating layers 608 and 658 upward through the overlying layers. In some implementations of the array of EMS devices shown in FIG. 6, the height 626 of the first step creating layer 608 can correspond to the height 622 of the first step 620. In some implementations, the height 676 of the second step creating layer 658 can correspond to the height 672 of the second step 670. As described above, the terms “correspondence” or “correspondingly” do not imply identicality, but rather merely reflect the degree of correspondence indicative of conformal depositions between the step creating layers 608 and 658 and the movable layers 616 and 666. Thus, the geometry of the steps 620 and 670 is not necessarily equal to the geometry of the step creating layers 608 and 658 as the depositions over the step creating layers 608 and 658 can cause some deviation or shifting of the geometry of the step. Accordingly, as the thicknesses 626 and 676 of the step creating layers 608 and 658 increase, the heights 622 and 672 of the steps 620 and 670 can increase. In some implementations of the array of EMS devices shown in FIG. 6, the height of the second step creating layer 658 is greater than the height of the first step creating layer 608.

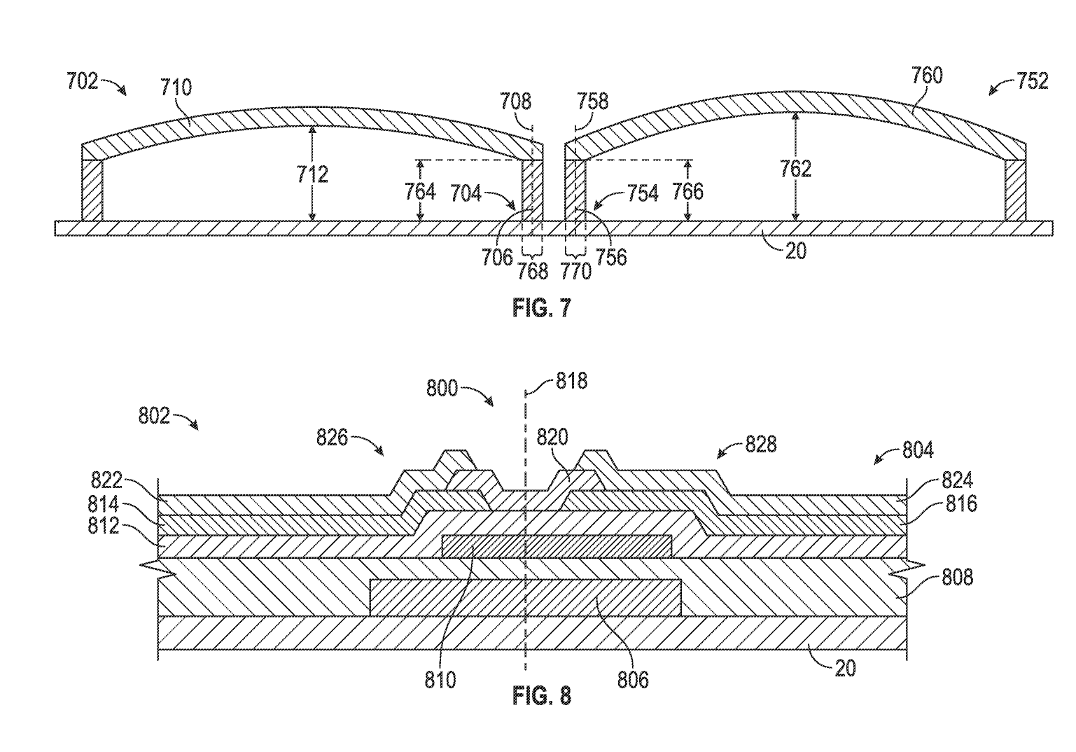

FIG. 7 is a cross-sectional illustration of a portion of an array of EMS devices. The array includes a first EMS device 702 and a second EMS device 752 arranged on a substrate 20. The first EMS device 702 includes a first anchoring region 704 including a support in the form of a first post 706. In other arrangements the supports may take other forms, such as continuous rails or walls. The post 706 shares a first geometric center point 708 with the first anchoring region 704. The first EMS device 702 includes a movable layer 710 spaced from the substrate by a first gap 712. The movable layer 710 is anchored to the substrate 20 at the first anchoring region 704.

The second EMS device 752 includes a second anchoring region 754 including a support in the form of a second post 756. In other arrangements the supports may take other forms, such as continuous rails or walls. The second post 756 shares a second geometric center point 758 with the second anchoring region 754. The second post 756 has a same height 766 relative to the substrate 20 as the height 764 of first post 706. The second post 756 also has a same width 770 as the width 768 of the first post 706. The second EMS device 752 includes a movable layer 760 spaced from the substrate 20 by a second gap 762. The first height of the first gap 712 is less than the height of the second gap 762.

Note that while FIG. 7 shows independent post structures 706 and 756 anchoring separate movable layers 710 and 760 to the substrate 20, any of FIGS. 5-7 can be implemented with support structures that are integrated with the movable layers, forming self-supporting movable layers (see FIGS. 2C and 2E). Independently formed supports, such as posts 706 and 756 of FIG. 7, have a width extending from one outer edge of the post to an opposite edge of the post. Support structures that are integrated with the movable layer, for example in self-supporting movable layers, can have their widths defined across edges defined by corners formed in the movable layers as they transition from approximately vertical to approximately horizontal (see FIG. 2E). Such corners form above the edge of the opening in a sacrificial layer into which the supports are formed, as can be understood from the unreleased state of FIG. 4D, except that the integrated movable layer and support would form the movable layer 14 and support 18 from the same material(s).

As depicted in FIG. 7, in some implementations, a first and second EMS device can be formed using a sacrificial layer of the same thickness and posts of the same height and width; nevertheless, after the sacrificial material is removed, due to different launch effects the first and second EMS devices have different gap heights. In some implementations, different launch effects can be combined with sacrificial layers of different thicknesses and/or posts of different heights and/or widths to affect gap height.

Gap height can be defined in a biased or an unbiased state. Bias can refer to an electric potential between an electrode in the movable layer and an electrode positioned on the substrate, spaced from the movable layer by a gap. Bias can cause the movable layer to deviate from its natural (unbiased) state after release of the EMS device.

As described with respect to FIG. 3, after removal of the sacrificial layer, an EMS device can be referred to as a ‘released’ EMS device. Launch can occur after removal of the sacrificial layer. In some implementations, upon release of the EMS device, the movable layer of the device can move toward or away from the substrate. This deviation of the position of the movable layer from an unreleased state to a released state can be referred to as ‘launch’. Launch can be measured as a deviation of the position of the movable layer, relative to the substrate, from an unreleased state to a released state, when the movable layer is in an unbiased state. In some implementations, launch can be a result of residual stress, for example, tensile stress, in the movable layer. In some implementations, launch can be determinative of the gap height of an EMS device.

As shown in FIGS. 5 and 6, in some implementations, a step in the movable layer can be used to affect launch. In some implementations, launch can be increased by increasing the distance by which the step is spaced from the geometric center point of the anchoring region. For example, FIG. 5 depicts a second step 570 spaced a greater distance from the geometric center point 560 than the distance by which the first step 520 is spaced from the first geometric center point 510. The second movable layer 566 can define a height for the second gap that is higher than a height for the first gap defined by the first movable layer 516. In one implementation, the first step 520 is spaced from the first geometric center point 510 by about 4.5-5.5 μm, while the second step 570 is spaced from the second geometric center point 560 by about 6-7 μm.

In some implementations, launch can be increased by increasing the height of the step in the movable layer. For example, FIG. 6 depicts a second step 670 having a greater height 672 than the height 622 of the first step 620. In some implementations, the second movable layer 666 can define a height for the second gap 668 that is higher than a height of the first gap 618 defined by the first movable layer 616. In one implementation, the height 622 of the first step 620 can be about 80-180 nm, while the height 672 of the second step 670 can be about 210-310 nm.

While the steps of FIGS. 5 and 6 are shown as steps down, extending towards the substrate 20, in some implementations the steps can be steps up, extending away from the substrate. In some implementations, the step can include a step down as well as a step up.

FIG. 8 is a cross-sectional illustration of an example of an anchoring region 800 between two EMS devices. FIG. 8 shows a first EMS device 802 and a second EMS device 804 arranged on a substrate 20. The anchoring region 800 includes a layer 806 that extends between the first EMS device 802 and the second EMS device 804. In an IMOD implementation, the layer 806 can include a light absorbing structure, such as a black mask. For example, the layer 806 can be an etalon black mask including sub-layers configured to interferometrically produce a dark appearance, such as a semireflective optical absorber layer, a transparent spacer layer and a reflective layer. The layer 806, or a portion thereof, can also serve as a signal bussing layer, in some implementations.

The anchoring region 800 includes a planarizing layer 808 above the layer 806 and extending between the first EMS device 802 and the second EMS device 804. In some implementations, the planarizing layer 808 can be formed from spin on glass (SOG). To serve as an effective bussing layer, a conductive sub-layer of the layer 806 can be relatively thick, for example, about 130-580 nm, such that the overlying planarization can facilitate layer formation over the layer 806.

The anchoring region 800 includes a step creating layer 810 above the planarizing layer 808, and extending between the first EMS device 802 and the second EMS device 804. The step creating layer 810 can serve as a bussing layer. Layers positioned over the step creating layer 810 can be conformal over the step creating layer 810 and the step created by the edges of the step creating layer 810 can be propagated upward through subsequently deposited layers.

The step creating layer 810 is depicted as extending farther into the second EMS device 804 than the first EMS device 802. The anchoring region 800 can include an isolation layer 812 above the layer 810. For implementations in which the step creating layer 810 is a conductor, the isolation layer 812 can include a dielectric material, and in IMOD implementations the isolation layer can include other sub-layers as described above for the optical stack.

The first EMS device 802 includes a first sacrificial layer 814 and the second EMS device 804 includes a second sacrificial layer 816 positioned over the step creating layer 810. The first and second sacrificial layers 814 and 816 are conformal over the underlying step creating layer 810. The shape of the step creating layer 810 can then be propagated through the isolation layer 812, causing a step in the first and second sacrificial layers 814 and 816. Because the step creating layer 810 extends farther into the second EMS device 804 than the first EMS device 802, the step in the second sacrificial layer 816 is spaced farther from a geometric center point 818 of the anchoring region 800 than the step in the first sacrificial layer 814.

A support structure 820 is positioned over the first and second sacrificial layers 814 and 816 in the anchoring region 800, centered around the geometric center point 818. The first EMS device 802 includes a first movable layer 822 and the second EMS device includes a second movable layer 824 positioned over the support structure 820. The support structure 820 can be a separate post, as shown in FIG. 8, or can be integrated with the movable layers in the case of self-supporting movable layers. The first and second movable layers 822 and 824 can be conformal over the first and second sacrificial layers 814 and 816, respectively. The steps in the sacrificial layers 814 and 816 can be propagated through to the movable layers 822 and 824. The first movable layer 822 can include a first step 826; and the second movable layer 824 can include a second step 828. The second step 828 can be laterally spaced farther from the geometric center point 818 of the anchoring region 800 than the first step 826. After release, or removal of the first and second sacrificial layers 814 and 816, the second EMS device 804 can, in some implementations, have a gap height greater than that of the first EMS device 802. This can be the case even where the sacrificial layers 814 and 816 have the same thickness, as illustrated, although the sacrificial layers can have different thickness in some embodiments.

FIG. 8 illustrates a shared anchoring region between two different EMS devices having two different step creating layers for devices with two different gap heights after release. At the same time, the drawing can represent differences in the step creating layers for independent anchoring regions of different EMS devices. While the step creating layer is shown as differing for the two devices in length from the geometric center, in other implementations the step creating layer can differ in thickness (as shown in FIG. 6), or can differ in both thickness and length from the geometric center of the anchoring region.

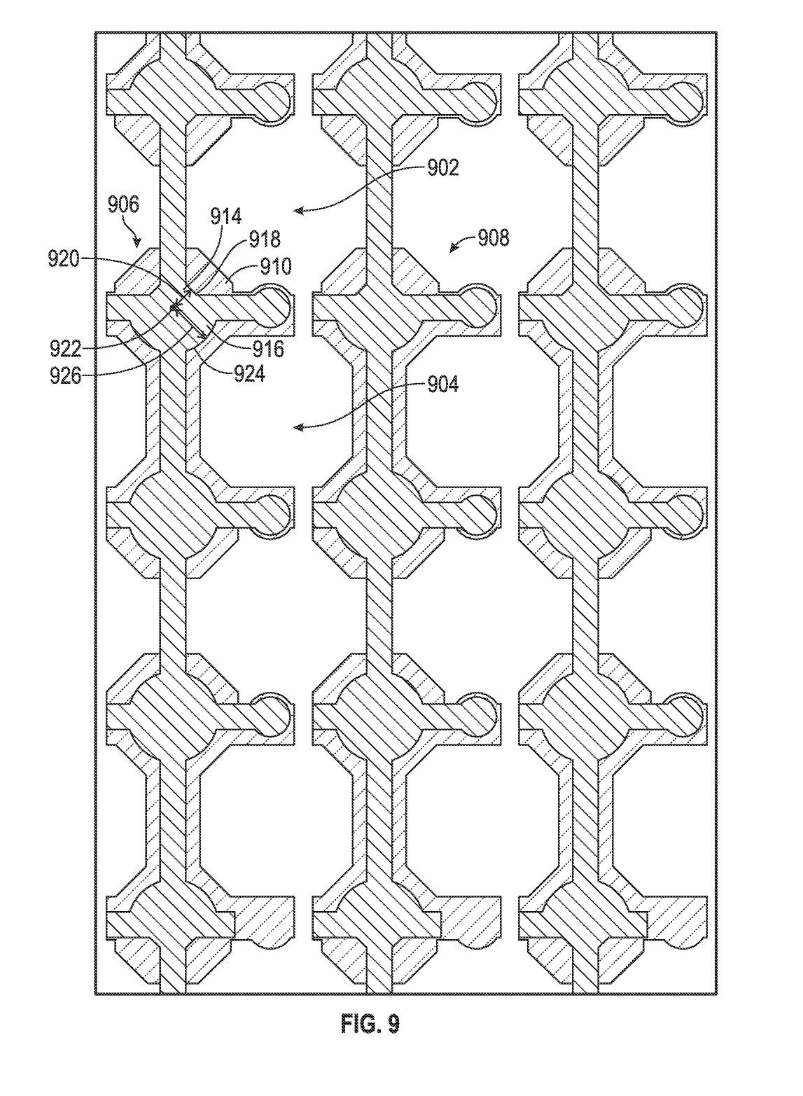

FIG. 9 is a plan view illustration of an array of EMS devices. The array of EMS devices includes a first EMS device 902 and a second EMS device 904. The first EMS device 902 and the second EMS device 904 share anchoring regions 906 and 908. Focusing on anchoring region 906, a black mask layer 910 is shown in the anchoring region 906 and extending between the two devices 902 and 904, such that, in an IMOD implementation, the black mask layer 910 can prevent reflections from the support regions and can also serve as a signal bussing layer, as described above.

The first EMS device 902 includes a first step creating layer 914 and the second EMS device 904 includes a second step creating layer 916 in the anchoring region 906 and positioned above the black mask layer 910. The step creating layers 914 and 916 can also serve as second bussing layers if the underlying black mask layer 910 serves as first bussing layer. FIG. 9 shows the step creating layers 914 and 916 as portions of a single layer, as they can be deposited/patterned at one time where they have the same thicknesses and differ only in lateral dimensions, such as the length from the geometric center of the anchoring region. One having ordinary skill in the art, however, will appreciate that the step creating layers can be separately formed (e.g. separately deposited and/or patterned) if they are to have different thicknesses in order to create separate step heights in the overlying movable layers. An edge 918 of the first step creating layer 914 can be spaced a first distance 920 from a geometric center point 922 of the anchoring region 906. An edge 924 of the second step creating layer can be spaced a second distance 926 from the geometric center point 922 of the anchoring region 906. As shown in FIG. 9, the first distance 920 can be less than the second distance 926. As discussed with respect to FIG. 8, subsequently deposited layers can conform to the step creating layers 914 and 916; and the step created by the edges of the step creating layers 914 and 916 can be propagated through layers positioned above the step creating layers 914 and 916. For example, the step in the step creating layers 914 and 916 can be propagated through intervening isolation and sacrificial layers to movable layers of the first and second EMS devices 902 and 904. The dimensions of the step creating layers 914 and 916 can correspond to dimensions of steps in subsequently deposited movable layers, as described above.

As noted above, gap height upon launch can be increased by increasing the distance of an edge of the step creating layer from the geometric center point of the anchor region and/or by increasing the height of the step creating layer. While FIG. 9 shows that the second EMS device 904 has a second step creating layer 916 spaced a greater distance from the geometric center point 922 of the anchoring region 906, FIG. 9 does not depict the height of the step creating layer. In some implementation, a first step creating layer 914 that is sufficiently higher than the second step creating layer 916 could result in the first EMS device 902 having a higher gap height than the second EMS device 904.

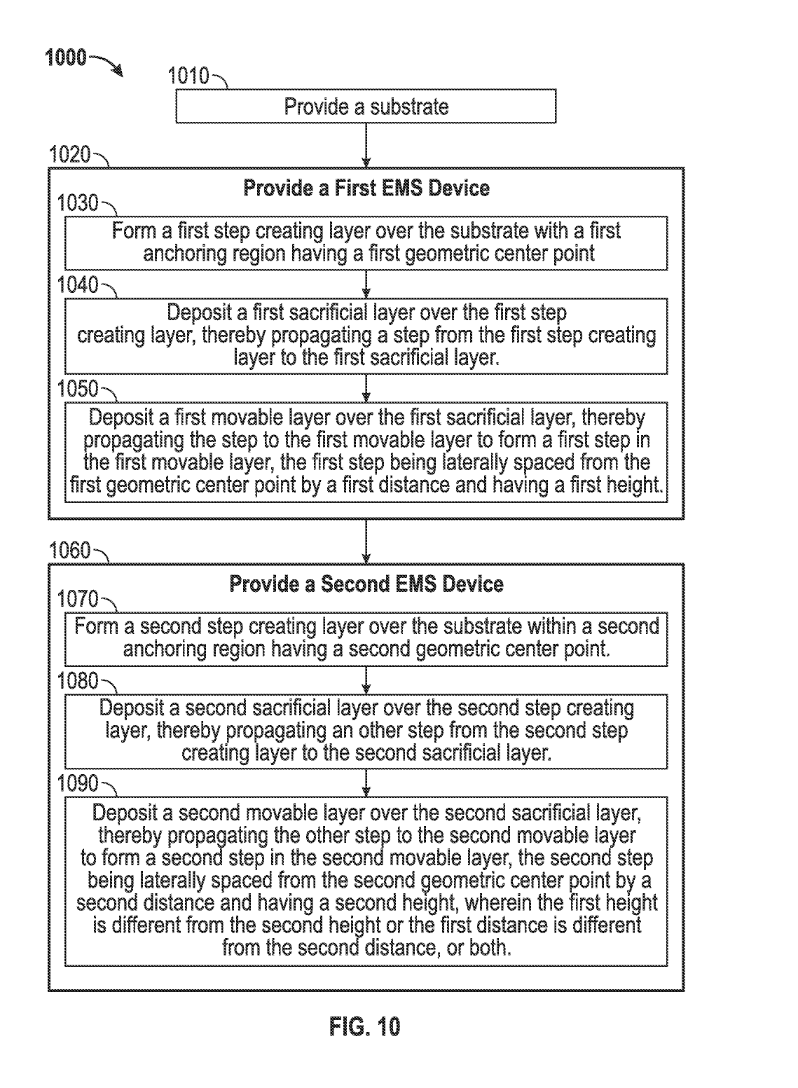

FIG. 10 is a flow diagram illustrating a manufacturing process for an array of EMS devices. The manufacturing process 1000 includes providing a substrate at block 1010, and providing a first EMS device at block 1020. Providing a first EMS device includes forming a first step creating layer over the substrate within a first anchoring region at block 1030. The edge of the first step creating layer is spaced a first length from a first geometric center point of the first anchoring region. The first step creating layer can have a thickness. Providing a first EMS device includes depositing a first sacrificial layer over the first step creating layer at block 1040, thereby propagating a step from the first step creating layer to the first sacrificial layer. At block 1050, providing a first EMS device includes depositing a first movable layer over the first sacrificial layer, thereby propagating the step from the first sacrificial layer to the first movable layer to form a first step in the first movable layer. The deposited first movable layer can be anchored to the substrate at the first geometric center point. The first step in the first movable layer is laterally spaced from the first geometric center point by a first distance corresponding to the first length where the first step has a first height.

The manufacturing process 1000 includes providing a second EMS device at block 1060 and, at block 1070, forming a second step creating layer over the substrate within a second anchoring region. An edge of the second step creating layer is spaced a second length from a second geometric center point of the second anchoring region. The second step creating layer having a thickness. In some implementations, the second step creating layer has a thickness different from the thickness of the first step creating layer. Providing a second EMS device includes depositing a second sacrificial layer over the second step creating layer at block 1080, thereby propagating an other step from the second step creating layer to the second sacrificial layer. At block 1090, providing a second EMS device includes depositing a second movable layer over the second sacrificial layer, thereby propagating the other step from the second sacrificial layer to the second movable layer to form a second step in the second movable layer. The deposited second movable layer can be anchored to the substrate at the second geometric center point. The second step in the second movable layer is laterally spaced from the second geometric center point by a second distance corresponding to the second length, where the second step has a second height different from the first height.

In some implementations, the first sacrificial layer and the first movable layer are deposited so they are conformal over the first step creating layer. In some implementations, the second sacrificial layer and the second movable layer are deposited so they are conformal over the second step creating layer.

In some implementations, depositing the first and second sacrificial layers includes forming a single thickness of sacrificial material.

In some implementations, the process 1000 can include removing the sacrificial layer to form a first gap having a first gap height in the first EMS device and a second gap having a second gap height, different from the first gap height, in the second device. The difference in gap heights can be due to different launch effects, which in turn can be due to the differences in step height or location.

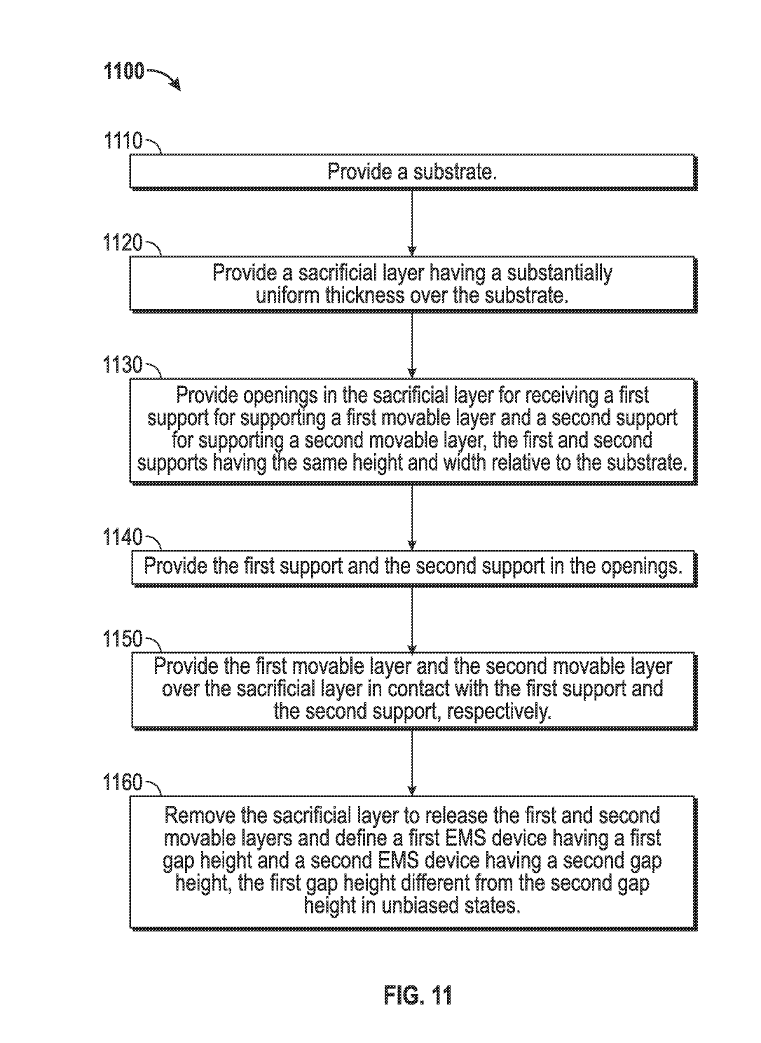

FIG. 11 is a flow diagram illustrating a manufacturing process for an array of EMS devices. The manufacturing process 1100 includes providing a substrate at block 1110 and providing a sacrificial layer having a substantially uniform thickness over the substrate at block 1120. The process 1100 includes providing openings in the sacrificial layer for receiving a first support for supporting a first movable layer and a second support for supporting a second movable layer at block 1130. The first and second supports have the same height and width relative to the substrate. The process 1100 includes providing the first support and the second support in the openings at block 1140. The process includes providing the first movable layer and the second movable layer over the sacrificial layer in contact with the first support and the second support, respectively, at block 1150. In some implementations, where the movable layers are self-supporting, blocks 1140 and 1150 can be conducted simultaneously. At block 1160, the process 1100 includes removing the sacrificial layer to release the first and second movable layers and define a first EMS device having a first gap height and a second EMS device having a second gap height, where the first gap height is different from the second gap height in unbiased states.

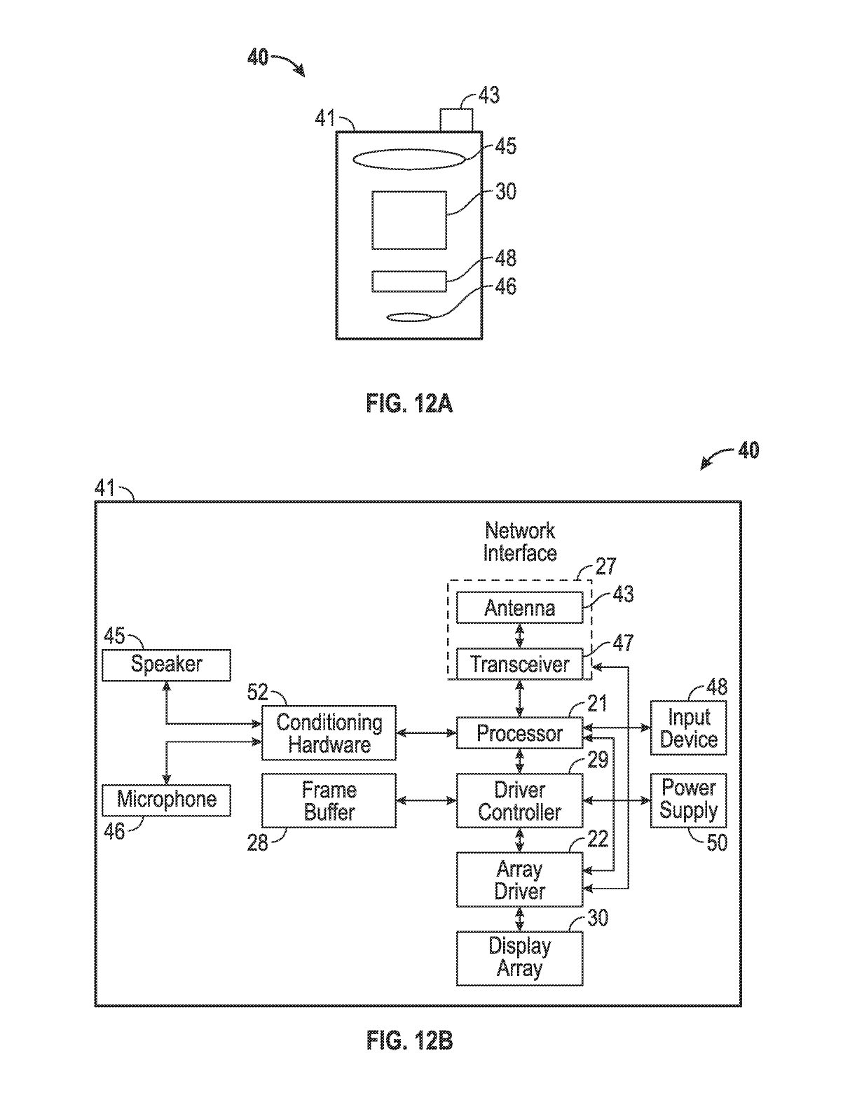

FIGS. 12A and 12B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

In some implementations, the display 30 includes an array of EMS devices. The display 30 can include a first and a second EMS device. The first and second EMS devices can have different gap heights, leading to different reflected interferometric colors in the open condition. The first and second EMS devices can have a first and a second step in their movable layers, respectively, affecting launch of the movable layers. The height and location of the steps can affect gap height. In some implementations, only differential launch effect is employed to produce the different gap heights, and support structures can be similarly dimensioned for different EMS with different gap heights.

The components of the display device 40 are schematically illustrated in FIG. 12A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 12A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. An array of electromechanical systems (EMS) devices, comprising:
a substrate;
a first EMS device including:
a first step creating layer within a first anchoring region, and
a first movable layer spaced from the first step creating layer and spaced from the substrate by a first gap, the first movable layer anchored to the substrate at the first anchoring region, the first anchoring region having a first geometric center point in a lateral plane, the first movable layer including a first step having a first height and laterally spaced from the first geometric center point by a first distance; and
a second EMS device including:
a second step creating layer within a second anchoring region, and
a second movable layer spaced from the second step creating layer and spaced from the substrate by a second gap, the second movable layer anchored to the substrate at the second anchoring region, the second anchoring region having a second geometric center point in a lateral plane, the second movable layer including a second step having a second height and laterally spaced from the second geometric center point by a second distance,
wherein the first distance is different from the second distance or the first height is different from the second height, or both.

2. The array of electromechanical systems devices of claim 1, wherein, in unbiased states, the second movable layer defines a height for the second gap that is higher than a height for the first gap defined by the first movable layer.

3. The array of EMS devices of claim 2, wherein an edge of the first step creating layer is spaced a first length from the first geometric center point, an edge of the second step creating layer is spaced a second length from the second geometric center point, and the second length is longer than the first length.

4. The array of EMS devices of claim 1, wherein the first movable layer and the second movable layer exhibit curvature away from the substrate in an unbiased state.

5. The array of EMS devices of claim 1, wherein at least one of the first and second step creating layers includes a signal bussing layer.

6. The array of EMS devices of claim 1, wherein the first step is spaced from the first geometric center point by about 4.5 μm-5.5 μm and the second step is spaced from the second geometric center point by about 6 μm-7 μm.

7. The array of EMS devices of claim 1, wherein the first EMS device and the second EMS device are interferometric modulators.

8. The array of EMS devices of claim 7, wherein an edge of the first step creating layer is spaced a first length from the first geometric center point, an edge of the second step creating layer is spaced a second length from the second geometric center point, the first EMS device and the second EMS device include black mask structures within the first and the second anchoring regions and extending a length from the geometric center points of the first and the second anchoring regions, the length longer than the first and second lengths.

9. The array of EMS devices of claim 1, wherein the first height is about 80 nm-180 nm and the second height is about 210 nm-310 nm.

10. The array of EMS devices of claim 1, wherein a thickness of the first step creating layer corresponds to the first height and a thickness of the second step creating layer corresponds to the second height.

11. The array of EMS devices of claim 10, wherein, in unbiased states, the second movable layer defines a height for the second gap that is higher than a height for the first gap defined by the first movable layer, and wherein second height of the second step is higher than the first height of the first step.

12. A display apparatus including:
a display, wherein the array of EMS devices of claim 1 is configured as an array of display elements;
a processor that is configured to communicate with the display, the processor being configured to process image data; and
a memory device that is configured to communicate with the processor.

13. The display apparatus of claim 12, further including:
a driver circuit configured to send at least one signal to the display; and
a controller configured to send at least a portion of the image data to the driver circuit.

14. The display apparatus of claim 12, further including:
an image source module configured to send the image data to the processor, wherein the image source module includes at least one of a receiver, transceiver, and transmitter.

15. The display apparatus of claim 12, further including:
an input device configured to receive input data and to communicate the input data to the processor.

16. A method of manufacturing an array of electromechanical systems (EMS) devices, comprising:
providing a substrate;
providing a first EMS device, including:
forming a first step creating layer over the substrate in a first anchoring region having a first geometric center point,
depositing a first sacrificial layer over the first step creating layer, thereby propagating a step from the first step creating layer to the first sacrificial layer, and
depositing a first movable layer over the first sacrificial layer, thereby propagating the step to the first movable layer to form a first step in the first movable layer, the first step being laterally spaced from the first geometric center point by a first distance and having a first height;
providing a second EMS device, including:
forming a second step creating layer over the substrate in a second anchoring region having a second geometric center point,
depositing a second sacrificial layer over the second step creating layer, thereby propagating an other step from the second step creating layer to the second sacrificial layer, and
depositing a second movable layer over the second sacrificial layer, thereby propagating the other step to the second movable layer to form a second step in the second movable layer, the second step being laterally spaced from the second geometric center point by a second distance and having a second height;
wherein the first height is different from the second height or the first distance is different from the second distance, or both.

17. The method of claim 16, wherein the first step creating layer has a first thickness and has an edge spaced a first length from the first geometric center point, wherein the second step creating layer has a second thickness and has an edge spaced a second length from the second geometric center point, and wherein the first thickness is different from the second thickness or the first length is different from the second length, or both.

18. The method of claim 16, wherein depositing the first sacrificial layer and depositing the first movable layer are conformal depositions over the first step creating layer, and depositing the second sacrificial layer and depositing the second movable layer are conformal depositions over the second step creating layer.

19. The method of claim 16, wherein depositing the first sacrificial layer and depositing the second sacrificial layer includes forming a single thickness of sacrificial material in the first and second EMS devices.

20. The method of claim 16, further including:
removing the sacrificial layer to form a first gap having a first gap height in the first EMS device and a second gap having a second gap height in the second EMS device, the first gap height being different from the second gap height in unbiased states.

21. The method of claim 16, wherein the first EMS device and the second EMS device are interferometric modulators.

22. The method of claim 21, wherein the first EMS device and the second EMS device are configured to reflect different colors.

23. An array of electromechanical systems (EMS) devices, comprising:
a substrate;
a first EMS device on the substrate including:
a stationary electrode;
a first movable electrode; and
a first launch defining means for defining a degree of deviance of the first movable electrode from an unreleased state to a released and unbiased state, the first launch defining means spaced by a gap from the first movable electrode;
a second EMS device on the substrate including:
a stationary electrode;
a second movable electrode; and
a second launch defining means for defining a degree of deviance of the second movable electrode from an unreleased state to a released and unbiased state, the second launch defining means spaced by a gap from the second movable electrode,
wherein the first launch defining means and the second launch defining means differ in one or more characteristics.

24. The array of EMS devices of claim 23, wherein the first and second launch defining means include first and second step creating layers, respectively.

25. The array of EMS devices of claim 23, wherein the first launch defining means has a different height than the second launch defining means.

26. The array of EMS devices of claim 23, wherein the first launch defining means is spaced a first distance from a geometric center point of a first anchoring region of the first movable electrode, and the second launch defining means is spaced a second distance from a geometric center point of a second anchoring region of the second movable electrode, and wherein the first distance is different from the second distance.

27. The array of EMS devices of claim 23, wherein the first launch defining means includes a first layer within the first anchoring region and the second launch defining means include a second layer within the second anchoring region.

28. The array of EMS devices of claim 23, wherein the first EMS device and the second EMS device are interferometric modulators configured to reflect different colors.

29. The array of EMS devices of claim 28, wherein the first launch defining means includes a layer positioned over a black mask structure and the second launch defining means includes a layer positioned over a black mask structure.

30. An array of electromechanical systems (EMS) devices, comprising:
a substrate;
a first EMS device and a second EMS device on the substrate,
the first EMS device including:
a first movable layer;
a first support for supporting the first movable layer and spacing the first movable layer from the substrate by a first gap,
the second EMS device including:
a second movable layer;
a second support for supporting the second movable layer and spacing the second movable layer from the substrate by a second gap,
wherein the first support and the second support have a same width and a same height relative to the substrate, and
the first EMS device and the second EMS device have different gap heights in unbiased states.

31. The array of EMS devices of claim 30, wherein the first support is integrated with the first movable layer to form a first self-supporting movable layer and the second support is integrated with the second movable layer to form a second self-supporting movable layer.

32. The array of EMS devices of claim 31, wherein a height of the second gap is higher than a height of the first gap.

33. The array of EMS devices of claim 32, wherein an edge of the first step creating layer is spaced a first distance from a geometric center point of the first support and an edge of the second step creating layer is spaced a second distance from a geometric center point of the second support and wherein the second distance is longer than the first distance.

34. The array of EMS devices of claim 32, wherein the first EMS device includes a first step creating layer in a first anchor region about the first support and the second EMS device includes a second step creating layer in a second anchor region about the second support, the first step creating layer spaced from the first movable layer and the second step creating layer spaced from the second movable layer, wherein a height of the second step creating layer is higher than a height of the first step creating layer.

35. The array of EMS devices of claim 34, wherein the first EMS device and the second EMS device share a same post, and wherein an edge of the first step creating layer is spaced a first distance from a first geometric center point of the post and an edge of the second step creating layer is spaced a second distance from a second geometric center point of the post, the first distance being different from the second distance.

36. The array of EMS devices of claim 30, wherein the first movable layer includes a first step and the second movable layer includes a second step, the first step spaced a first distance from a first geometric center point of the first support and the second step spaced a second distance from a second geometric center point of the second support, wherein the first distance is different from the second distance and/or the first and second steps have a different height.

37. The array of EMS devices of claim 36, wherein
the first EMS device includes a first step creating layer in a first anchor region about the first support and the second EMS device includes a second step creating layer in a second anchor region about the second support, the first step creating layer spaced from the first movable layer and the second step creating layer spaced from the second movable layer, and, the second step creating layer having a greater thickness than the first step creating layer, and
the height of the first step corresponds to the thickness of the first step creating layer and the height of the second step corresponds to the thickness of the second step creating layer.

38. The array of EMS devices of claim 36, wherein
the first EMS device includes a first step creating layer in a first anchor region about the first support and the second EMS device includes a second step creating layer in a second anchor region about the second support, the first step creating layer spaced from the first movable layer and the second step creating layer spaced from the second movable layer, and, an edge of the first step creating layer spaced a first length from a first geometric center point of the first support and an edge of the second step creating layer spaced a second length from a second geometric center point of the second support, wherein the second length is longer than the first length, and
the first distance corresponds to the first length and the second distance corresponds to the second length.

39. The array of EMS devices of claim 30, wherein the first EMS device and the second EMS device are interferometric modulators and the first EMS device interferometrically reflects a different color than the second EMS device.

40. The array of EMS devices of claim 39, wherein the first EMS device includes a first step creating layer spaced from the first movable layer and the second EMS includes a second step creating layer spaced from the second movable layer, the first step creating layer having a first thickness and the second step creating layer having a second thickness, an edge of the first step creating layer spaced a first length from a first geometric center point of the first support and an edge of the second step creating layer spaced a second length from a second geometric center point of the second support, wherein the height of the second gap is higher than the height of the first gap in unbiased states.

41. The array of EMS devices of claim 40, wherein the second thickness is greater than the first thickness and/or the second length is greater than the first length.

42. The array of EMS devices of claim 40, wherein the first step creating layer is positioned over a black mask structure and around the first support of the first EMS device and the second step creating layer is positioned over a black mask structure and around the second support of the second EMS device.

43. A display apparatus including:
a display, wherein the array of EMS devices of claim 30 is configured as an array of display elements;
a processor that is configured to communicate with the display, the processor being configured to process image data; and
a memory device that is configured to communicate with the processor.

44. The display apparatus of claim 43, further comprising:
a driver circuit configured to send at least one signal to the display; and
a controller configured to send at least a portion of the image data to the driver circuit.

45. The display apparatus of claim 43, further comprising:
an image source module configured to send the image data to the processor, wherein the image source module comprises at least one of a receiver, transceiver, and transmitter.

46. The display apparatus of claim 43, further comprising:
an input device configured to receive input data and to communicate the input data to the processor.

47. A method of manufacturing an array of electromechanical systems (EMS) devices, comprising:
providing a substrate;
providing a sacrificial layer having a substantially uniform thickness over the substrate;
providing openings in the sacrificial layer for receiving a first support for supporting a first movable layer and a second support for supporting a second movable layer, the first and second supports having the same height and width relative to the substrate;
providing the first support and the second support in the openings;
providing the first movable layer and the second movable layer over the sacrificial layer in contact with the first support and the second support, respectively; and
removing the sacrificial layer to release the first and second movable layers and define a first EMS device having a first gap height and a second EMS device having a second gap height, the first gap height different from the second gap height in unbiased states.

48. The method of claim 47, wherein removing the sacrificial layer causes the first and second movable layers to launch, curving away from the substrate.

49. The method of claim 47, further comprising providing a first step creating layer in the first EMS device, the first step creating layer spaced from the movable layer by the sacrificial layer and a second step creating layer in the second EMS device, the second step creating layer spaced from the second movable layer by the sacrificial layer.

50. The method of claim 49, wherein the second gap height is greater than the first gap height, wherein the first step creating layer has a first thickness and is spaced from a geometric center point of the first support by a first length and wherein the second step creating layer has a second thickness and is spaced from a geometric center point of the second support by a second length, and wherein the second thickness is higher than the first thickness and/or the second length is longer than the first length.

51. The method of claim 47, wherein the first support is integrated with the first movable layer to form a first self-supporting movable layer and the second support is integrated with the second movable layer to form a second self-supporting movable layer.

52. The method of claim 49, further comprising providing a black mask structure on the substrate, the black mask structure under the first step creating layer and the second step creating layer.
